(19) United States
(12) Patent Application Publication
(10) Pub. No.: US 2025/0360462 A1
(43) Pub. Date: Nov. 27, 2025

(54) REACTOR AND APPARATUS FOR TREATING EFFLUENT GAS STREAM

(71) Applicant: BHT SERVICES PTE. LTD., Kallang (SG)

(72) Inventor: Chee-Wei CHAN, Kallang (SG)

(21) Appl. No.: 19/215,781

(22) Filed: May 22, 2025

Related U.S. Application Data
(60) Provisional application No. 63/651,550, filed on May 24, 2024.

(51) Int. Cl. B01D 53/76; B01D 53/18; B01D 53/75; H05B 6/64; H05B 6/70; H05B 6/78; H05B 6/80

(52) U.S. Cl. CPC B01D 53/76; B01D 53/18; B01D 53/75; H05B 6/6491; H05B 6/707; H05B 6/784; H05B 6/802; B01D 2252/103; B01D 2258/0216; B01D 2259/806

(57) ABSTRACT

A reactor for treating gaseous pollutants includes an inlet module, a reaction module, one or more microwave modules, and a susceptor. The inlet module includes one or more guiding conduits configured to guide an effluent stream from a process. The reaction module is in fluid communication with the inlet module and includes a body and a reaction chamber. The guiding conduit is connected to the reaction chamber. The microwave module includes a microwave generation unit and a waveguide unit, wherein the waveguide unit is connected to the reaction chamber and configured to transmit microwave radiation generated by the microwave generation unit into the reaction chamber. The susceptor is disposed within the reaction chamber and configured to receive the microwave radiation from the waveguide unit and convert the microwave radiation into thermal energy.

### FIELD OF THE INVENTION

The present invention relates to a reactor and apparatus for treating effluent gas stream, particularly a reactor and apparatus that utilize microwave-induced thermal decomposition for effluent gases.

### BACKGROUND OF THE INVENTION

In industries such as manufacturing, electronics, and chemical engineering, including semiconductor, display, solar panel, and thin-film processes, various gaseous pollutants containing harmful chemical substances are produced. Common treatment methods include combustion, plasma, water scrubbing, and catalytic processing. Among them, combustion and plasma methods have higher decomposition efficiency. Conventional devices, such as those disclosed in U.S. Pat. Nos. 12,161,964B2, 12,158,266B2, 11,985,754B2, and publications US 2024/0375158A1, US 2024/0381519A1, and US 2024/0082782A1, present limitations.

However, combustion-based treatment systems require fuel, leading to high energy consumption, greenhouse gas emissions, and costly maintenance, with relatively large equipment sizes. Plasma-based systems, while effective, involve complex electrical configurations, high procurement costs, lower stability, and potential electromagnetic interference issues.

### SUMMARY OF THE INVENTION

The present disclosure describes a reactor for treating an effluent gas stream, comprising an inlet module, a reaction module, one or more microwave modules and a susceptor. The reaction module includes one or more guiding conduits configured to direct an effluent stream from one or more processes. The reaction module is fluidly connected to the inlet module, the reaction module including a body and a reaction chamber defined by the body, wherein the guiding conduit of the inlet module communicates with the reaction chamber. The microwave modules are connected to the reaction module, each including a microwave generating unit and a waveguide unit connected to the microwave generating unit, the waveguide unit being connected to the reaction chamber and configured to transmit microwave radiation generated by the microwave generating unit to the reaction chamber. The susceptor is disposed within the reaction chamber. The susceptor is configured to receive the microwave radiation from the waveguide unit and convert the microwave radiation into thermal energy, wherein temperature within the reaction chamber when the microwave modules are activated is at least 1000° C.

The present disclosure further describes an apparatus for treating an effluent gas stream, comprising a reactor, a water tank and a secondary reactor. The water tank is connected downstream of the reactor to receive the effluent stream from the reactor. The secondary reactor connected to the water tank to receive the effluent stream flowing through the water tank.

### BRIEF DESCRIPTION OF THE DRAWINGS

Examples of the present disclosure will be described with reference to the accompanying drawings briefly described below.

FIG. 1 is a schematic block diagram of an exemplary thermal reactor.

FIG. 2A is a perspective view of an exemplary thermal reactor.

FIG. 2B is an exploded perspective view of FIG. 2A.

FIG. 2C is a transverse sectional view of FIG. 2A.

FIG. 3 is a perspective sectional view of FIG. 2A.

FIG. 4 is a longitudinal sectional view of FIG. 2A.

FIG. 5A is a perspective view of another exemplary thermal reactor.

FIG. 5B is an exploded perspective view of the exemplary thermal reactor in FIG. 5A.

FIG. 6 is a perspective sectional view of FIG. 5A.

FIG. 7 is a longitudinal sectional view of FIG. 5A.

FIG. 8 is a perspective view of an effluent gas stream treatment system.

### DETAILED DESCRIPTION

The present disclosure is generally directed to a reactor for processing gaseous pollutants, specifically a thermal reactor, which can serve as an abatement device for treating effluent streams from semiconductor, display panel, solar panel, and other manufacturing processes. Examples of pollutants treated include waste gas contaminants such as perfluorinated compounds (PFCs), silane and its derivatives, chlorinated compounds, nitrogen-containing compounds, volatile organic compounds (VOCs), and metal-organic compounds, which are harmful to the environment and human health. This thermal reactor can function as a standalone gas pollution treatment device or be integrated into a gas pollution treatment system as one of its components. For instance, the thermal reactor may be a part of a combustion-and-scrubbing type exhaust treatment system or a combustion-based exhaust treatment system.

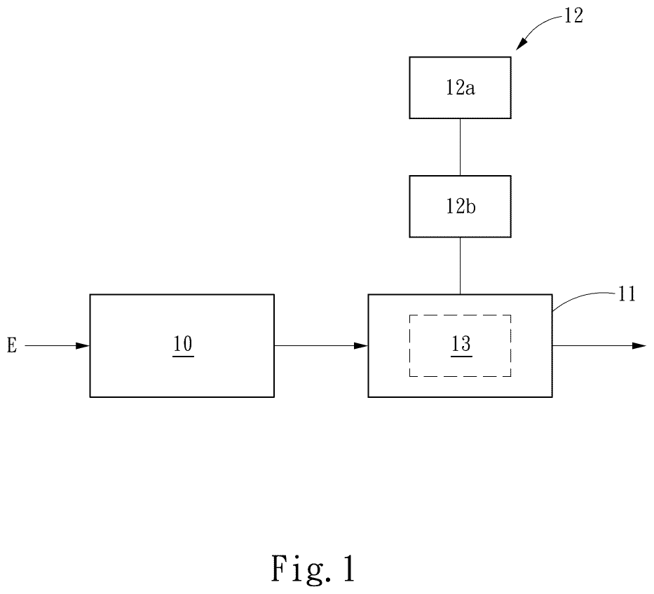

FIG. 1 illustrates a block diagram of an example of the thermal reactor, comprising an inlet module 10, a reaction module 11, a microwave module 12, and a susceptor 13. The inlet module 10 is configured to guide an effluent stream E from a process into the reaction module 11. The susceptor 13 is disposed within the reaction module 11, and the combination of the susceptor 13 and the microwave module 12 generates high temperatures and heat within the reaction module 11 to decompose the effluent stream E. The microwave module 12 includes a microwave generating unit 12a and a waveguide unit 12b connected to the microwave generating unit 12a. The microwave generating unit 12a is connected to a power source and generates microwave radiation, while the waveguide unit 12b transmits the microwave radiation and directs it to the susceptor 13. The reaction module 11 is configured to allow the effluent stream E to pass through a thermal zone formed as a result of microwave-induced heating of the susceptor 13.

Through the combination of microwave radiation and the susceptor 13, a high temperature sufficient for thermal decomposition can be achieved in a very short time with relatively low power consumption.

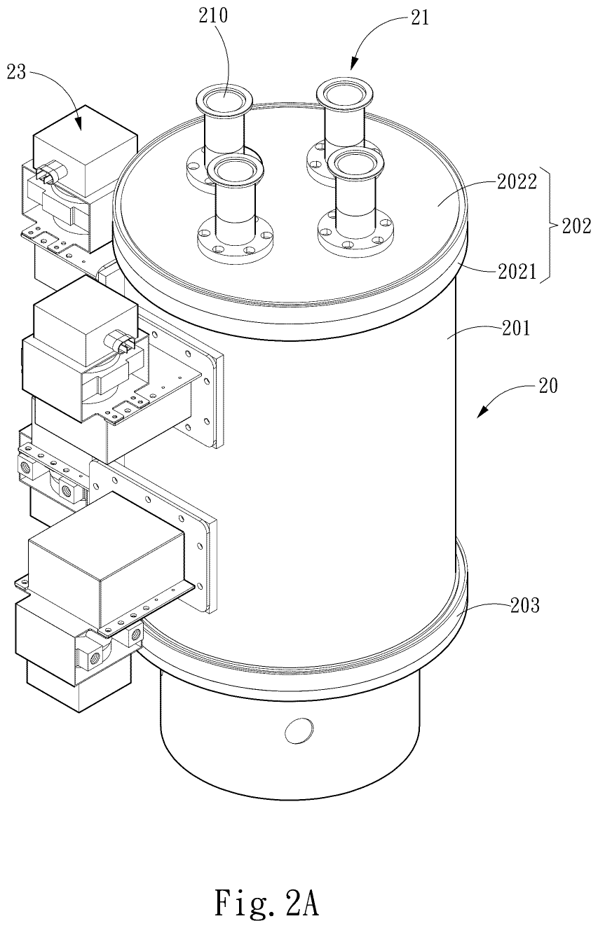

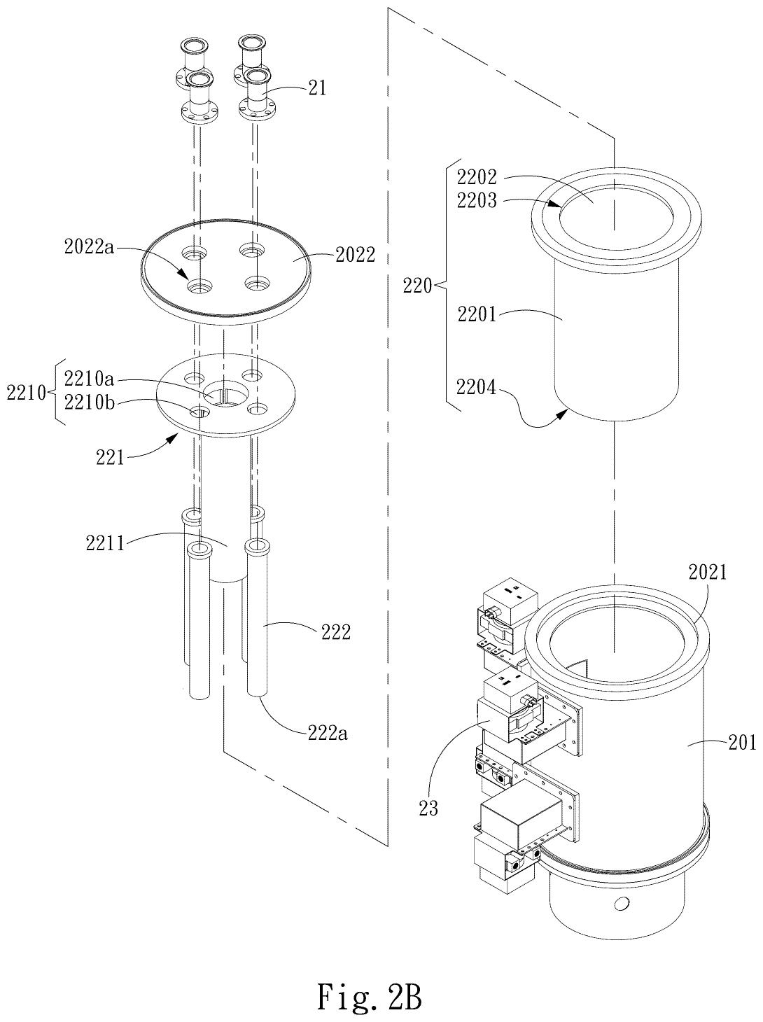

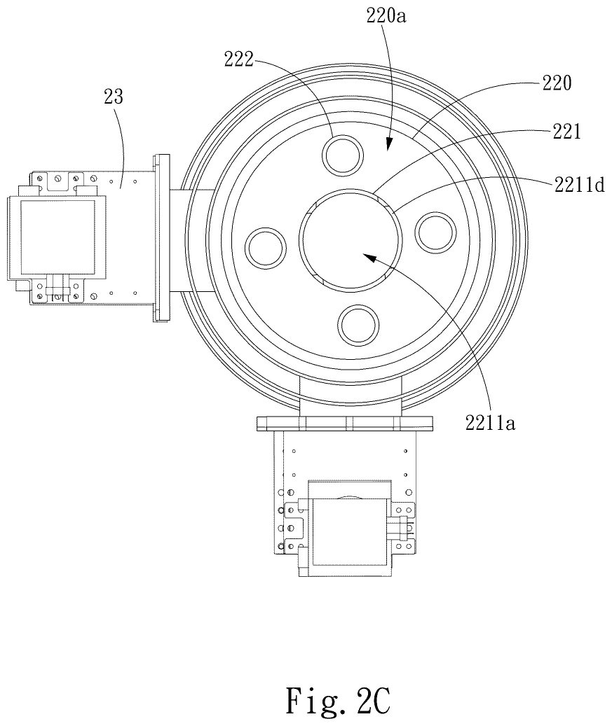

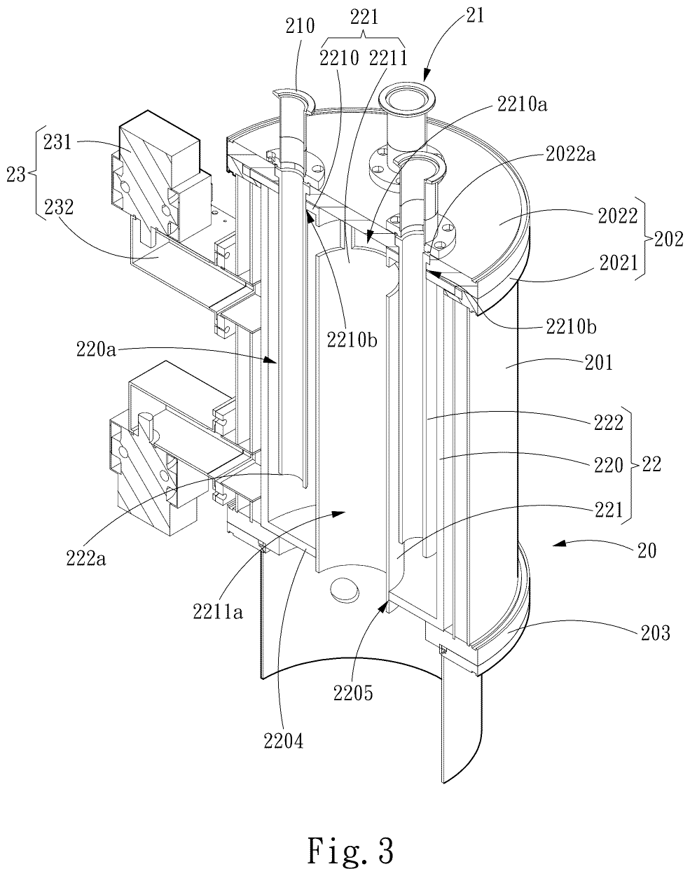

FIGS. 2A through 4 illustrate schematic diagrams of the thermal reactor according to one example. The thermal reactor includes an abatement unit 20, one or more inlet pipes 21, one or more susceptor assembly 22, and one or more microwave modules 23. The abatement unit 20 comprises an outer cylinder 201, a top assembly 202, and an annular base 203. The outer cylinder 201 is mounted on the annular base 203, which is connected to downstream components of the thermal reactor, such as a water tank or a wet scrubber. The top assembly 202 is disposed on the outer cylinder 201 and includes a flange 2021 and a lid 2022. The flange 2021 is mounted on the outer cylinder 201, and the lid 2022 is mounted on the flange 2021. The abatement unit 20 defines a chamber that is divided into an upper region 20a-1, a middle region 20a-2, and a lower region 20a-3. In the example, there are four inlet pipes 21, and the lid 2022 has four first ports 2022a, with the inlet pipes 21 mounted on the first ports 2022a. The effluent stream is injected into the chamber through an inlet end 210 of the inlet pipes 21. The inlet pipes 21 are arranged vertically, i.e., perpendicular to a plane or horizontal surface (or the ground) of the lid 2022. In other examples, the inlet pipes 21 may be arranged at an incline, such as at an angle between 60 and 90 degrees relative to the plane or horizontal surface.

In some examples, the abatement unit 20 may be referred to as the reaction module and the chamber defined by the abatement unit 20 may be referred to as the reaction chamber.

The susceptor assembly 22 includes an outer sleeve 220, an inner sleeve 221, and multiple tubes 222. In one example, the outer sleeve 220, the inner sleeve 221, and the tubes 222 each comprise the same or different susceptor material(s) (e.g., the inner sleeve 221 may be made of a combination of a susceptor material and another material). In another example, the outer sleeve 220, the inner sleeve 221, and the tubes 222 are made of the same or different susceptor material(s) (e.g., the inner sleeve 221 may be made of a susceptor material). In yet another example, at least one or more of the outer sleeve 220, the inner sleeve 221, and the tubes 222 may be made of susceptor material(s). For instance, only the outer sleeve 220 and the inner sleeve 221 may be made of susceptor material(s), while the tubes 222 may be made of a non-susceptor material.

Referring to FIG. 2C, the outer sleeve 220 and the inner sleeve 221 are both cylindrical but have different diameters. The inner sleeve 221 has a smaller diameter than the outer sleeve 220 and is coaxially disposed within the outer sleeve 220, thereby defining an annular space 220a. The tubes 222, which are also cylindrical, are disposed within the annular space 220a. In the example, the tubes 222 are arranged axially symmetrically with respect to the inner sleeve 221. The outer sleeve 220, the inner sleeve 221 and the tubes 222 are all extended in the same direction to form a coaxial arrangement.

The outer sleeve 220 is disposed within the chamber of the abatement unit 20 and includes a barrel 2201 with an annular wall portion 2202, an upper opening 2203 and a bottom plate 2204. The inner sleeve 221 includes a top plate 2210 and a hollow insert 2211. The top plate 2210 is seated on the upper opening 2203 of the outer sleeve 220, and the hollow insert 2211 extends downward from a central region of the top plate 2210 through an interior space of the barrel 2201 and down to a bottom hole 2205 on the bottom plate 2204.

The top plate 2210 of the inner sleeve 221 has a central perforation 2210a and four second ports 2210b. The lid 2022 of the top assembly 202 is disposed on the top plate 2210 of the inner sleeve 221. The hollow insert 2211 of the inner sleeve 221 defines a hollow portion 2211a and has a first end 2211b connected to the top plate 2210 and a second end 2211c opposite the first end 2211b.

The first end 2211b includes one or more inlet ports 2211d, which extend through the top of an annular wall of the hollow insert 2211. The hollow portion 2211a of the hollow insert 2211 fluidly communicates with the downstream end of a gas flow channel within the annular space 220athrough the inlet ports 2211d. In the example, the inlet ports 2211d are laterally oriented openings formed in the annular wall of the hollow insert 2211. The hollow portion 2211a has a bottom opening 2211e, and the hollow insert 2211 extends downward to the bottom hole 2205 on the bottom plate 2204 of the outer sleeve 220, either passing through or beyond the bottom hole 2205 in the example.

The lid 2022 is placed atop the top plate 2210 and over the central perforation 2210a to close it off, so the effluent stream flows downward through the hollow portion 2211a after entering from the inlet ports 2211d. The second ports 2210b are arranged around the central perforation 2210aand correspond to the first ports 2022a of the lid 2022. The second ports 2210b allow the inlet pipes 21 to connect with the tubes 222, forming the gas flow channel end-to-end.

The tubes 222 are located within the annular space 220a. The tubes 222 extend downward from the lid 2022, with each outlet end 222a positioned in the lower region 20a-3. In other words, an exhaust port of the gas flow channel is close to, but does not contact, the bottom plate 2204. As a result, the effluent stream E discharged from the outlet end 222a flows into the annular space 220a.

In some examples, the outer sleeve 220 may be referred to as the body of the reaction module, which has an annular wall portion. In some examples. The combination of the inlet pipes 21 and the tubes 222 may be collectively referred to as the guiding conduits, which may be or belong to a part of the inlet module. While in other examples, the guiding conduits may only include the inlet pipes 21, which are inserted into the body of the reaction module.

In some examples, the abatement unit 20 may be referred to as the body of the reaction module. The top assembly 202, the annular base 203, and the outer cylinder 201 of the abatement unit 20 may respectively be referred to as the top portion, the bottom portion, and the annular wall portion of the body. The susceptor assembly 22 extends from the top portion of the body to an outlet opening (e.g., the bottom hole 2205) provided on the bottom portion of the body. The annular space 220a) is defined between the top portion and the bottom portion, within the annular wall portion and surrounding the sleeve. The annular space is in fluid communication with the guiding conduit to introduce the effluent stream E and is also in fluid communication with the one or more inlet ports 2211d provided on the sleeve, so as to guide the effluent stream E into the hollow portion 2211a.

In some examples, the annular space 220a may be defined between a top portion and a bottom portion, within the annular wall portion 2202, and surrounding the inner sleeve 221. The annular space 220a is in fluid communication with the guiding conduit to introduce the effluent stream E and in fluid communication with the one or more inlet ports 2211d disposed on the inner sleeve 221 to guide the effluent stream E into the hollow portion 2211a.

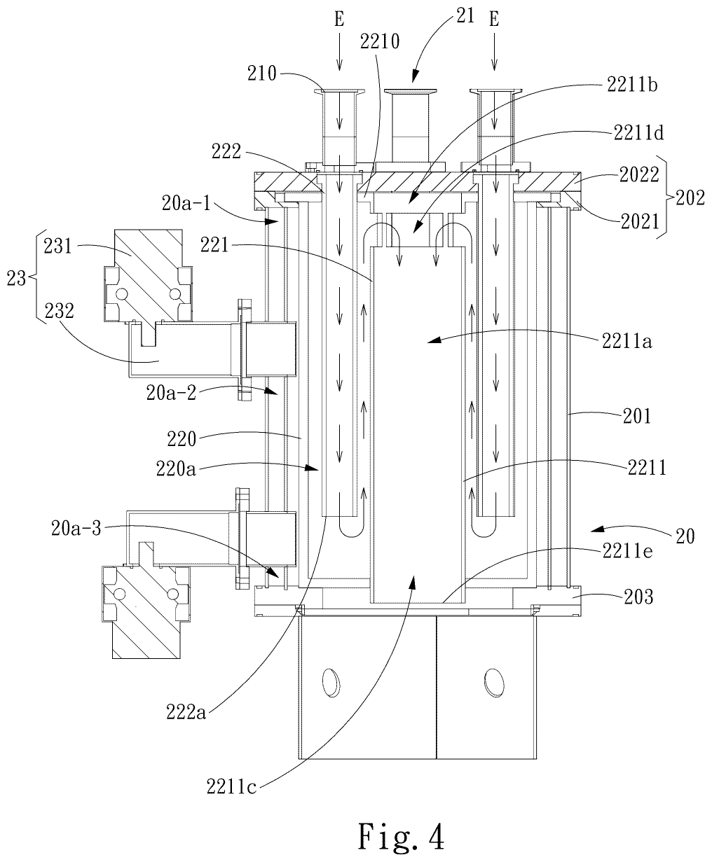

As shown in FIG. 4, in the example, after entering through the inlet end 210 of the inlet pipes 21, the effluent stream E flows downward through the tubes 222, exiting from the outlet end 222a into the annular space 220a of the outer sleeve 220. The effluent stream E then flows upward and inward through the inlet ports 2211d of the hollow insert 2211 into the hollow portion 2211a, before flowing downward again and exiting through the bottom opening 2211e.

The microwave module 23 includes a microwave generating unit 231 and a waveguide unit 232 connected to the microwave generating unit 231. The microwave module 23 is attached to an outer annular wall of the outer cylinder 201. The waveguide unit 232 transmits microwave radiation generated by the microwave generating unit 231 to the susceptor assembly 22 located within the chamber of the abatement unit 20. In an example, the outer sleeve 220, the inner sleeve 221 and the tubes 222 are all made of a susceptor material and may be referred to as the susceptor. The susceptor may define one or more passageways, such as the passageway defined by the tube 222, the passageway defined by the annular space 220a, and/or the passageway defined by the inner sleeve 221.

The susceptor is configured to receive the microwave radiation from the waveguide unit 232 and convert the microwave radiation into thermal energy, which is transferred into the one or more passageways defined by the outer sleeve 220, the inner sleeve 221, and the tubes 222. Under operating conditions, the temperature within the reaction chamber reaches at least 1000° C.

As shown in FIG. 4, the effluent stream E flows in a direction that is substantially perpendicular to one or more transmission directions of the microwave radiation provided by the waveguide unit 232. In this example, the transmission directions may be lateral directions that are perpendicular to a sidewall of the susceptor, for example, a cylindrical wall of the outer sleeve 220, the inner sleeve 221, and/or the tubes 222.

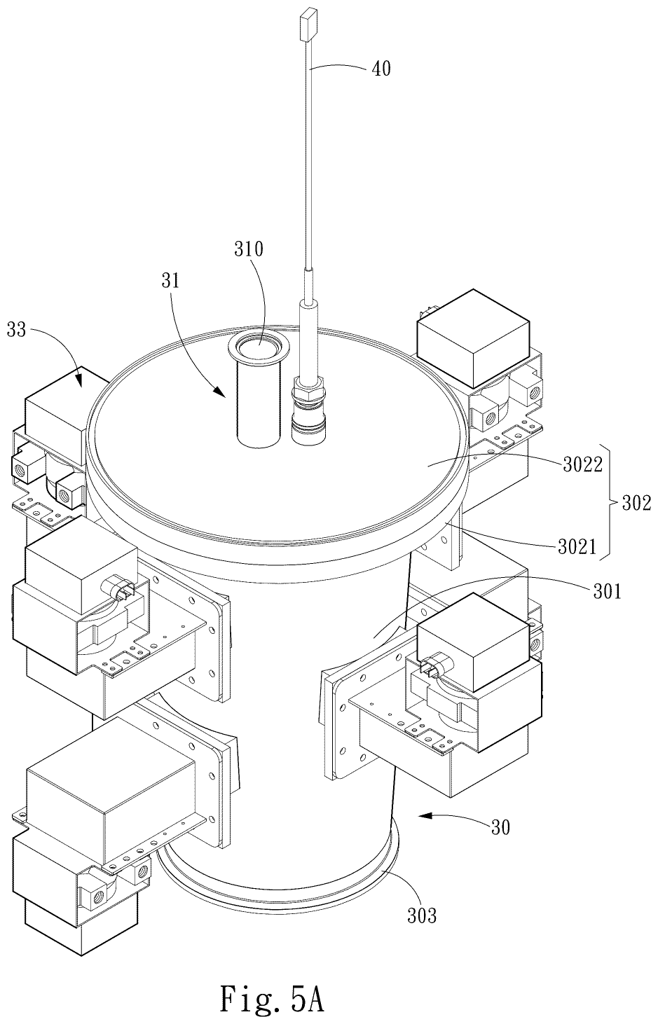

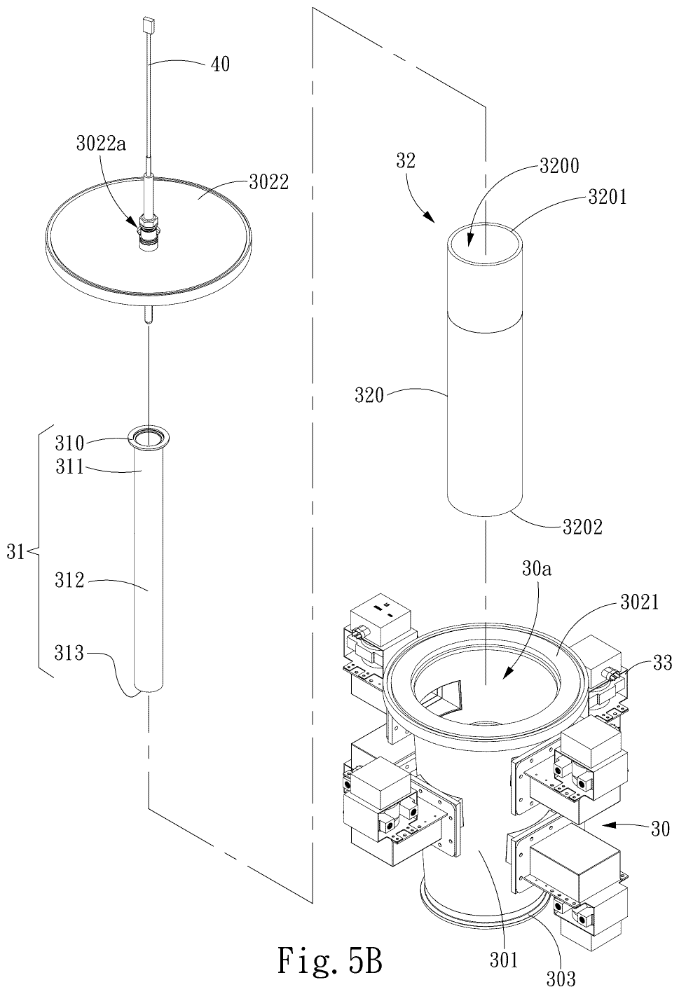

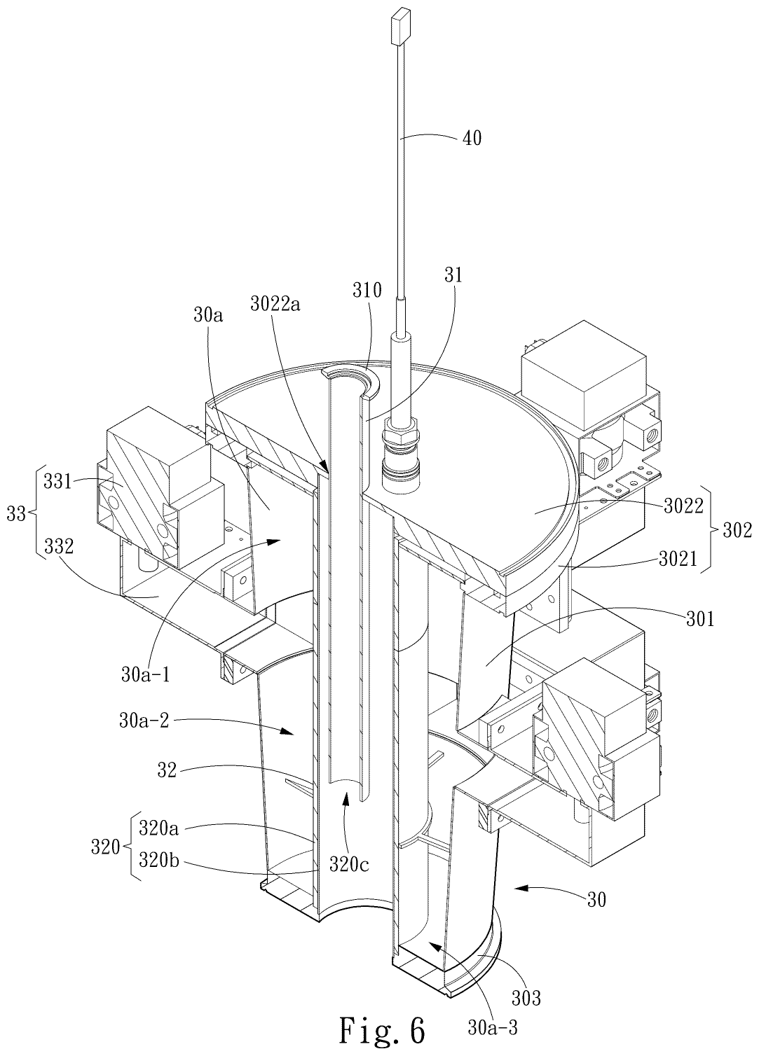

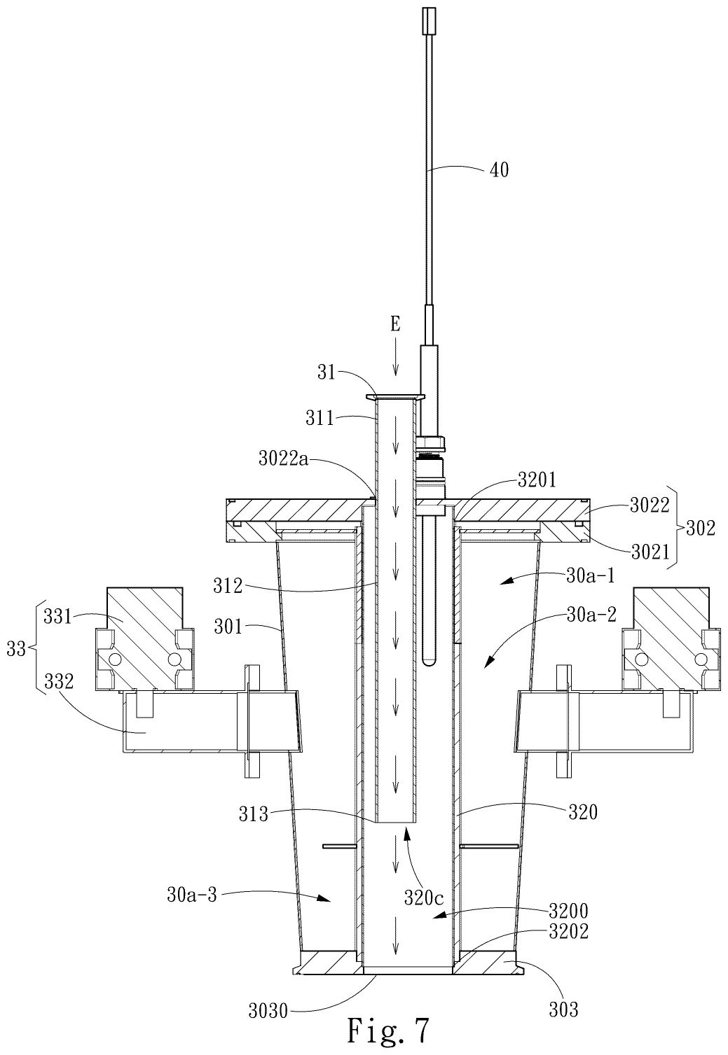

FIGS. 5A through 7 illustrate schematic diagrams of the thermal reactor according to another example. The thermal reactor includes a body 30, an inlet pipe 31, a susceptor assembly 32, and a plurality of microwave modules 33. The body 30 comprises an outer cylinder 301, a top assembly 302, and an annular base 303. The outer cylinder 301 is mounted on the annular base 303, which is connected downstream of the thermal reactor. Fon instance, the annular base 303 may be connected to a water tank or a wet scrubber. The top assembly 302 is disposed on the outer cylinder 301 and includes a flange 3021 and a lid 3022. The flange 3021 is mounted on the outer cylinder 301, and the lid 3022 is mounted on the flange 3021. The body 30 defines a chamber 30a, divided into an upper region 30a-1, a middle region 30a-2, and a lower region 30a-3. In this example, the thermal reactor further includes a temperature sensor 40.

In this example, there is a single inlet pipe 31, and the lid 3022 has an opening 3022a. The inlet pipe 31 passes through the opening 3022a of the lid 3022 and extends into the chamber 30a of the body 30. The effluent stream is injected into the chamber 30a through an inlet 310 of the inlet pipe 31. The inlet pipe 31 is arranged vertically, i.e., perpendicular to a plane or horizontal surface (or the ground) of the lid 3022. In other examples, the inlet pipe 31 may be arranged at an incline, such as at an angle between 60 and 90 degrees relative to the plane or horizontal surface.

The susceptor assembly 32 includes a sleeve 320 made of materials including a susceptor material. In one example, the sleeve 320 is entirely composed of the susceptor material. The susceptor assembly 32 is disposed within the chamber 30a of the body 30. In this example, the sleeve 320 has a bilayer structure, including a first tubular layer 320a and a second tubular layer 320b, which is an outer layer and an inner layer, respectively. The first tubular layer 320a is made of an insulating material and the second tubular layer 320b is made of a susceptor material. In other examples, the sleeve 320 may have a single-layer structure or a multi-layer structure, provided that the sleeve 320 includes susceptor material, its specific structure or number of layers may vary.

The sleeve 320 is located below the lid 3022 and extends downward from a central region of the lid 3022 into the chamber 30a. The sleeve 320 has a hollow portion 3200, a top opening 3201, and a bottom opening 3202. The top opening 3201 connects to the opening 3022a of the lid 3022, and the hollow portion 3200 extends downward and connects to a central opening 3030 of the annular base 303, with the bottom opening 3202 aligning with the central opening 3030.

The inlet pipe 31 has a tube body, which includes a first section 311 and a second section 312. The first section 311 is located above the lid 3022 and outside the chamber 30a, while the second section 312 is located below the lid 3022 and within the hollow portion 3200 of the sleeve 320. The second section 312 extends downward and terminates above the bottom opening 3202 of the sleeve 320, i.e., an outlet 313 of the inlet pipe 31 is positioned above the bottom opening 3202 at a distance. The outlet 313 of the inlet pipe 31 in this example is located in the lower region 30a-3 of the chamber 30a. In other examples, the outlet 313 of the inlet pipe 31 may be located in the upper region 30a-1 or the middle region 30a-2 of the chamber 30a.

In some examples, the inlet pipe 31 may be referred to as the guiding conduit, and the second section 312 may be referred to as the exhaust section. In the example, one or more inlet ports may be defined on the sleeve 320, which may be referred to as a port 320c communicated with a downstream of the inlet pipe 31. In some examples, the top assembly 302 may be referred to as the top portion of the body 30, the outer cylinder 301 may be referred to as the annular wall portion of the body 30, and the annular base 303 may be referred to as the bottom portion of the body 30. The central opening 3030 may be referred to as the outlet opening formed on the annular base 303.

In this example, after entering through the inlet 310 of the inlet pipe 31, the effluent stream flows directly downward through the sleeve 320 of the susceptor assembly 32 and exits from the bottom opening 3202 of the sleeve 320.

The microwave module 33 includes a microwave generating unit 331 and a waveguide unit 332 connected to the microwave generating unit 331. The microwave module 33 is attached to an outer annular wall of the outer cylinder 301. The waveguide unit 332 transmits microwave radiation generated by the microwave generating unit 331 to the susceptor assembly 32 located within the chamber 30a of the body 30.

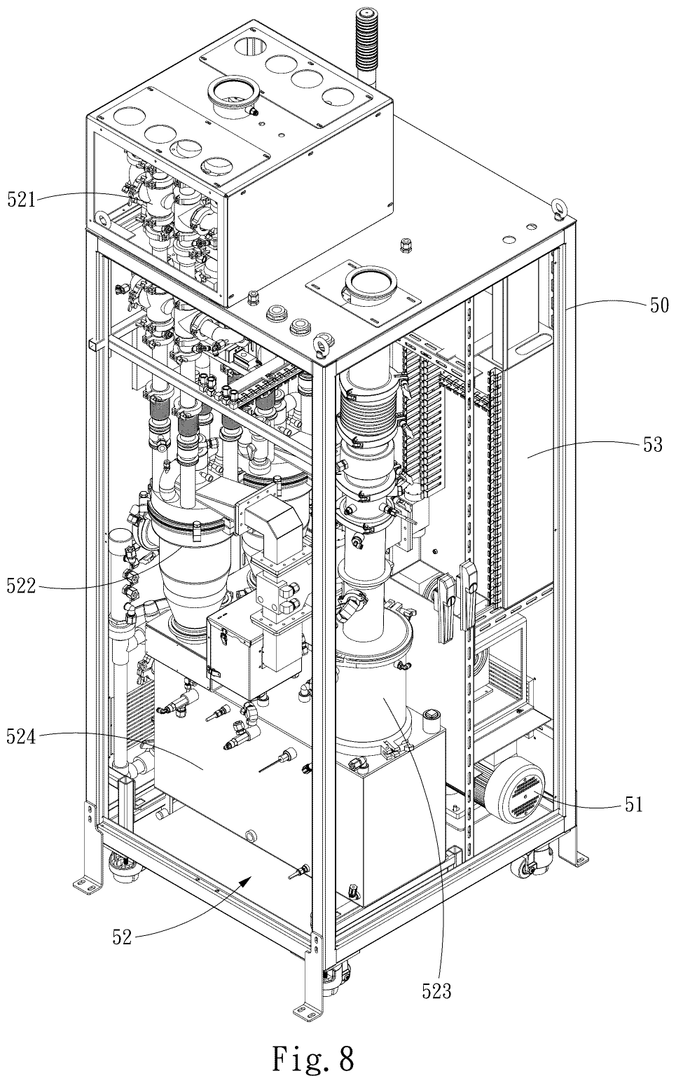

FIG. 8 illustrates a schematic diagram of an exemplary exhaust gas treatment apparatus. The apparatus includes a housing and multiple modules. The housing comprises a frame 50 and a plurality of removable doors, and the modules include a pump assembly 51, a reactor assembly 52, and an electronic and control assembly 53. In some examples, the apparatus further includes a gas supply system (e.g., a gas manifold panel) and one or more fluid delivery assemblies. The gas supply system may be used to deliver inert gases (e.g., nitrogen) or compressed dry air (CDA), while the fluid delivery assemblies may be used to deliver fresh water or cooling water.

The reactor assembly 52 includes an exhaust guiding device 521, a first-stage reactor 522, a second-stage reactor 523, and a water tank 524. The second-stage reactor 523 may be the thermal reactor described above, while the first-stage reactor 522 may be a packed scrubber tower.

While several examples have been illustrated and described, and while several illustrative examples have been described in considerable detail, the examples described are not intended to restrict or in any way limit the scope of the appended claims to such detail. In addition, various features from one of the examples may be incorporated into another of the examples. That is, it is believed that the disclosure set forth above encompasses multiple distinct examples with independent utility. While each of these examples has been disclosed in a preferred form, the specific examples thereof as disclosed and illustrated herein are not to be considered in a limiting sense as numerous variations are possible. The subject matter of the disclosure includes all novel and non-obvious combinations and subcombinations of the various elements, features, functions and/or properties disclosed herein.

Accordingly, it is appropriate that the appended claims be construed broadly and in a manner consistent with the scope of the disclosure as set forth in the following claims.

It is to be understood that terms such as “first,” “second,” “left,” “right,” “top,” “bottom,” “front,” “rear,” “side,” “upper,” “lower,” “interior,” “exterior,” “inner,” “outer” and the like as may be used herein, merely describe points of reference and do not limit the present disclosure to any particular orientation or configuration. Further, the term “exemplary” is used herein to describe an example or illustration. Any examples described herein as exemplary is not to be construed as a preferred or advantageous example, but rather as one example or illustration of a possible example of the disclosure.

The terms “comprise,” “include,” “have,” and the like, as used with respect to examples of the present disclosure, are synonymous. When used herein, the term “comprises” and its derivations (such as “comprising”, etc.) should not be understood in an excluding sense, that is, these terms should not be interpreted as excluding the possibility that what is described and defined may include further elements, steps, etc. The use of the terms “a” and “an” and “the” and similar referents in the context of describing the invention (especially in the context of the following claims) are to be construed to cover both the singular and the plural, unless otherwise indicated herein or clearly contradicted by context. Similarly, where no article is used, the term should also be construed to cover both the singular and the plural, unless the context clearly dictates otherwise.

Likewise, when the description refers to “a first” element or its equivalent, it should be understood to include one or more such elements, neither mandating nor precluding the presence of two or more such elements.

Additionally, for the purposes of this disclosure, the phrase “X and/or Y” means (X), (Y), or (X and Y), and the phrase “X, Y, and/or Z” means (X), (Y), (Z), (X and Y), (X and Z), (Y and Z), or (X, Y, and Z).

1. A reactor for treating an effluent gas stream, comprising:
an inlet module including one or more guiding conduits configured to direct an effluent stream from one or more processes;
a reaction module fluidly connected to the inlet module, the reaction module including a body and a reaction chamber defined by the body, wherein the guiding conduit of the inlet module communicates with the reaction chamber;
one or more microwave modules connected to the reaction module, each including a microwave generating unit and a waveguide unit connected to the microwave generating unit, the waveguide unit being connected to the reaction chamber and configured to transmit microwave radiation generated by the microwave generating unit to the reaction chamber; and
a susceptor disposed within the reaction chamber, the susceptor being configured to receive the microwave radiation from the waveguide unit and convert the microwave radiation into thermal energy;
wherein temperature within the reaction chamber when the microwave modules are activated is at least 1000° C.

2. The reactor according to claim 1, wherein the body includes an annular wall portion and a top assembly disposed on the annular wall portion, the annular wall portion defining the reaction chamber, and the waveguide unit of the microwave module being laterally connected to the annular wall portion and radiatively coupled to the reaction chamber.

3. The reactor according to claim 1, wherein the susceptor defines one or more passageways, the passageways being connected to a downstream of the guiding conduit.

4. The reactor according to claim 1, wherein the susceptor defines one or more passageways, the passageways being configured to receive the effluent stream from the guiding conduit and to allow the effluent stream to flow therethrough.

5. The reactor according to claim 1, wherein the susceptor includes a sleeve disposed within the reaction chamber and a hollow portion defined by the sleeve, the guiding conduit including an inlet end located outside the reaction chamber, an outlet end located within the reaction chamber, and a tube body connected between the inlet end and the outlet end and inserted into the body of the reaction module, the outlet end being in communication with the hollow portion to allow the effluent stream to flow through the hollow portion of the susceptor.

6. The reactor according to claim 1, wherein the guiding conduit is inserted into a top portion of the body, the guiding conduit including an inlet end located outside the reaction chamber, an outlet end located within the reaction chamber, and a tube body connected between the inlet end and the outlet end, the susceptor including a sleeve disposed within the reaction chamber and a hollow portion defined by the sleeve, the sleeve having an inner diameter greater than that of the tube body, and an exhaust section of the tube body of the guiding conduit being disposed within the hollow portion of the sleeve to allow the effluent stream to flow through the hollow portion of the susceptor.

7. The reactor according to claim 1, wherein the susceptor includes a sleeve disposed within the reaction chamber and a hollow portion defined by the sleeve, the sleeve having one or more inlet ports, wherein the inlet ports communicate with a downstream of the guiding conduit to allow the effluent stream to flow through the hollow portion of the susceptor.

8. The reactor according to claim 1, wherein the body includes a top portion, a bottom portion and an annular wall portion connected between the top portion and the bottom portion, and wherein the susceptor includes a sleeve disposed within the reaction chamber and a hollow portion defined by the sleeve, the sleeve being extended from the top portion of the body down to an outlet opening disposed on the bottom portion of the body, an annular space being defined between the top portion and the bottom portion, within the annular wall portion, and surrounding the sleeve, wherein the annular space is in fluid communication with the guiding conduit to introduce the effluent stream and in fluid communication with one or more inlet ports disposed on the sleeve to guide the effluent stream into the hollow portion.

9. The reactor according to claim 1, wherein the body includes an annular wall portion, the waveguide unit of the microwave module being connected to the annular wall portion to allow an output end of the waveguide unit to transmit the microwave radiation to the susceptor.

10. The reactor according to claim 1, wherein the waveguide unit is configured to transmit the microwave radiation along one or more lateral directions that are perpendicular to a flow direction of the effluent stream.

11. The reactor according to claim 1, wherein the waveguide unit is configured to transmit the microwave radiation along one or more lateral directions that are perpendicular to a sidewall of the susceptor.

12. The reactor according to claim 1, wherein the susceptor includes a sleeve disposed within the reaction chamber and a hollow portion defined by the sleeve, the microwave module being provided in plurality and arranged around the sleeve.

13. The reactor according to claim 12, wherein the waveguide unit is configured to transmit the microwave radiation along one or more lateral directions that are perpendicular to a cylindrical wall of the sleeve.

14. The reactor according to claim 1, wherein the susceptor includes a sleeve disposed within the reaction chamber and a hollow portion defined by the sleeve, the sleeve having a first tubular layer made from one or more susceptor materials and a second tubular layer made from one or more thermal insulation materials, the first tubular layer and the second tubular layer being sleeved with each other.

15. An apparatus for treating an effluent gas stream, comprising:
a reactor according to claim 1;
a water tank connected downstream of the reactor to receive the effluent stream from the reactor, and
a secondary reactor connected to the water tank to receive the effluent stream flowing through the water tank.
